(19) United States
(12) Patent Application Publication
(10) Pub. No.: US 2019/0324537 A1
(43) Pub. Date: Oct. 24, 2019

(54) STATE PREDICTION APPARATUS AND STATE PREDICTION METHOD

(71) Applicants: Toyota Jidosha Kabushiki Kaisha, Toyota-shi Aichi-ken (JP); The University of Tokyo, Bunkyo-ku Tokyo (JP)

(72) Inventors: Hirotaka Kaji, Hadano-shi Kanagawa-ken (JP); Masashi Sugiyama, Bunkyo-ku Tokyo (JP)

(73) Assignees: Toyota Jidosha Kabushiki Kaisha, Toyota-shi Aichi-ken (JP); The University of Tokyo, Bunkyo-ku Tokyo (JP)

(21) Appl. No.: 16/386,484

(22) Filed: Apr. 17, 2019

(30) Foreign Application Priority Data
Apr. 18, 2018 (JP) 2018-080015

(51) Int. Cl. G06F 3/01; G06K 9/62; G06N 20/00; B60W 50/00; B60W 40/09

(52) U.S. Cl. CPC G06F 3/015; G06K 9/6259; G06N 20/00; B60W 2040/0827; B60W 40/09; G06F 2203/011; B60W 50/0097

(57) ABSTRACT

A state prediction apparatus includes an information processing device. The information processing device is configured to acquire first input data related to at least one of biological information and action information of a user. The information processing device is configured to execute a prediction operation to predict a status of the user based on the first input data. The information processing device is configured to repeat a learning process for optimizing details of the prediction operation by using a first data portion and second data portion of second input data. The second input data is related to at least one of the biological information and action information of the user. The second input data is not associated with correct data indicating the status of the user. The second data portion is different from the first data portion.

### CROSS-REFERENCE TO RELATED APPLICATION

This application claims priority to Japanese Patent Application No. 2018-080015 filed on Apr. 18, 2018, incorporated herein by reference in its entirety.

### BACKGROUND

### 1. Technical Field

The disclosure relates to a technical field of, for example, a state prediction apparatus and state prediction method.

### 2. Description of Related Art

Japanese Unexamined Patent Application Publication No. 2013-120534 (JP 2013-120534 A) describes a classification apparatus that classifies a plurality of words into groups of related words. Particularly the classification apparatus described in JP 2013-120534 A repeats the operation of once classifying each of a plurality of words into any one of a plurality of classes obtained through a clustering method and reclassifying each of the plurality of words into any one of the plurality of classes based on a likelihood that the classified word belongs to a class into which the word is classified.

### SUMMARY

The inventors have been advancing development of a state prediction apparatus that is able to predict the status (for example, drowsiness or other statuses) of a human being based on human biological information (in addition, action information; the same applies to the following description). That is, the inventors have been advancing development of a state prediction apparatus that is able to classify the status of a human being, of which certain biological information has been observed, into any one of a plurality of states (that is, a plurality of groups or a plurality of classes) based on human biological information. However, human biological information has the characteristics that human biological information contains a relatively large amount of noise information that has relatively little correlation with the status of a human being. In addition, it is preferable from the viewpoint of clustering that similar pieces of biological information based on which the statuses of different human beings in the same state should be classified into the same class be observed from the different human beings in the same state; however, actually, totally different pieces of biological information based on which the statuses are classified into different classes can be observed from the different human beings in the same class. Moreover, it is preferable from the viewpoint of clustering that different pieces of biological information based on which the statuses should be classified into different classes be observed from the same human being in different states; however, actually, similar pieces of biological information based on which the statuses are classified into the same class can be observed from the same human being in different states. That is, human biological information has the characteristics that a plurality of classes that are obtained through clustering over pieces of human biological information tends to have overlaps.

For this reason, even when the classification method that the classification apparatus described in JP 2013-120534 A adopts is used in the state prediction apparatus that is able to predict the status of a human being based on biological information having such characteristics, it is difficult to appropriately perform clustering over biological information. As a result, the status of a human being may not be appropriately predicted.

The disclosure provides a state prediction apparatus and a state prediction method that are able to appropriately predict the status of a user based on at least one of biological information and action information of the user.

A first aspect of the disclosure relates to a state prediction apparatus. The state prediction apparatus includes an information processing device. The information processing device is configured to acquire first input data related to at least one of biological information and action information of a user. The information processing device is configured to execute a prediction operation to predict a status of the user based on the first input data. The information processing device is configured to repeat a learning process for optimizing details of the prediction operation by using a first data portion and second data portion of second input data. The second input data is related to at least one of the biological information and action information of the user. The second input data is not associated with correct data indicating the status of the user. The second data portion is different from the first data portion.

A second aspect of the disclosure relates to a state prediction method. The state prediction method includes acquiring first input data related to at least one of biological information and action information of a user, executing an prediction operation to predict a status of the user based on the first input data, and repeating a learning process for optimizing details of the prediction operation by using a first data portion and second data portion of second input data, the second input data being related to at least one of the biological information and action information of the user, the second input data being not associated with correct data indicating the status of the user, the second data portion being different from the first data portion.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram showing the configuration of a state prediction apparatus of an embodiment;

FIG. 2 is a flowchart showing the flow of a prediction operation;

FIG. 3 is a graph showing a waveform signal of electrocardiogram;

FIG. 4 is a waveform chart showing an RRI identifiable from the waveform signal;

FIG. 5 is a flowchart showing the flow of a learning operation;

FIG. 6 is a flowchart showing the flow of a learning process for optimizing a coefficient parameter α in step S26 of FIG. 5;

FIG. 7A is a graph showing the distribution of feature values in a feature vector space;

FIG. 7B is a graph showing the distribution of feature values in a feature vector space;

FIG. 7C is a graph showing the distribution of feature values in a feature vector space;

FIG. 7D is a graph showing the distribution of feature values in a feature vector space;

FIG. 7E is a graph showing the distribution of feature values in a feature vector space;

FIG. 7F is a graph showing the distribution of feature values in a feature vector space; and

FIG. 8 is a graph showing an F-measure on prediction of a degree of drowsiness in the case where a coefficient parameter is optimized through supervised learning by using learning data containing feature values associated with correct data, an F-measure on prediction of a degree of drowsiness in the case where the coefficient parameter is optimized through only once UU learning by using unlabeled data, and an F-measure on prediction of a degree of drowsiness in the case where the coefficient parameter is optimized through repeated multiple-time UU learning by using unlabeled data.

### DETAILED DESCRIPTION

Hereinafter, an embodiment of a state prediction apparatus will be described. Hereinafter, a state prediction apparatus 1 will be described as one embodiment of the state prediction apparatus according to the disclosure. The state prediction apparatus 1 is able to predict a degree of drowsiness of a driver of a vehicle based on an electrocardiogram waveform of the driver. The driver is one specific example of a user in the supplemental notes (described later).

### (1) Configuration of State Prediction Apparatus 1

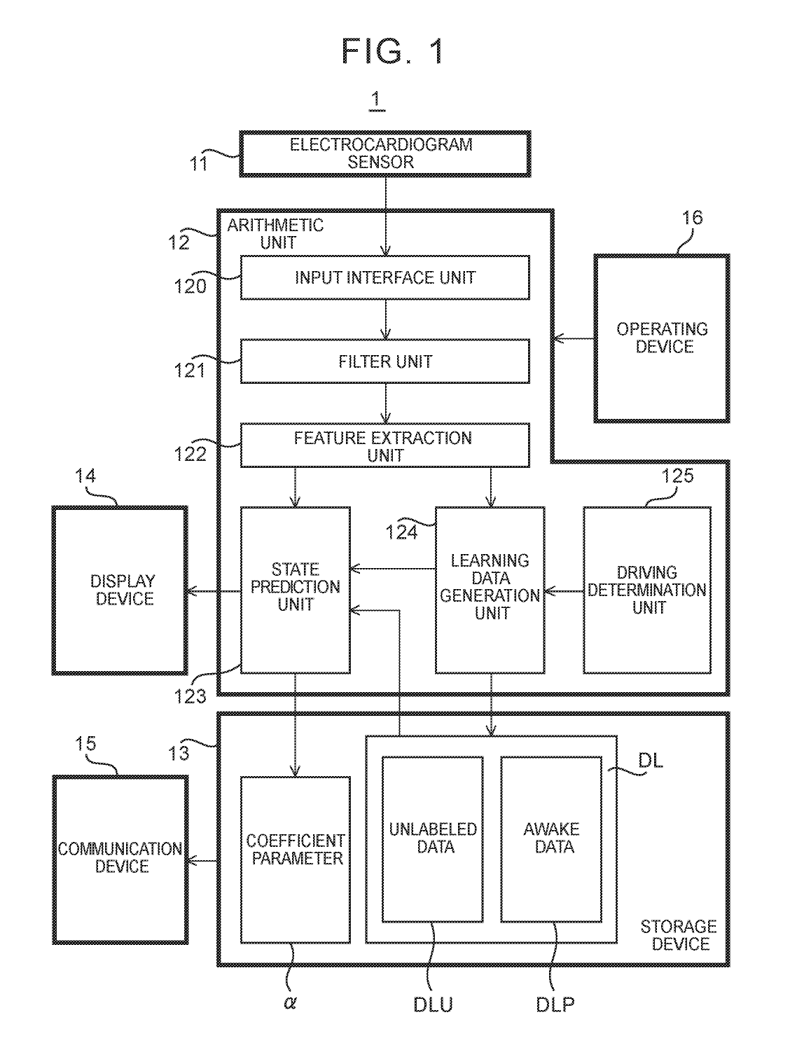

First, the configuration of the state prediction apparatus 1 of the present embodiment will be described with reference to FIG. 1. FIG. 1 is a block diagram showing the configuration of the state prediction apparatus 1 of the present embodiment.

As shown in FIG. 1, the state prediction apparatus 1 includes a electrocardiogram sensor 11, an arithmetic unit 12, a storage device 13, a display device 14, a communication device 15, and an operating device 16

The electrocardiogram sensor 11 is an electrocardiograph that is able to detect an electrocardiogram (that is, an electric signal that the heart produces) of the driver. A method with which the electrocardiogram sensor 11 detects the electrocardiogram may be any method. The electrocardiogram sensor 11 is, for example, a wearable sensor that can be attached to the chest of the driver. Instead, the electrocardiogram sensor 11 may be fixed to the vehicle. A detected result (that is, a waveform signal representing a temporal waveform of the electrocardiogram) of the electrocardiogram sensor 11 is output to the arithmetic unit 12.

The arithmetic unit 12 is an information processing device, such as a central processing unit (CPU). The arithmetic unit 12 predicts the degree of drowsiness of the driver based on the waveform signal that is output from the electrocardiogram sensor 11. Specifically, the arithmetic unit 12 predicts whether the driver is drowsy or not drowsy (that is, the driver is awake). To predict the degree of drowsiness, the arithmetic unit 12 includes an input interface unit 120, a filter unit 121, a feature extraction unit 122, a state prediction unit 123, a learning data generation unit 124, and a driving determination unit 125 as processing blocks that are logically constructed inside the arithmetic unit 12. The input interface unit 120 is one specific example of the configuration that “the information processing device is configured to acquire first input data” in the supplemental notes (described later). The state prediction unit 123 is one specific example of the configuration that “the information processing device is configured to execute a prediction operation” in the supplemental notes (described later). The input interface unit 120 acquires a waveform signal that is output from the electrocardiogram sensor 11. The filter unit 121 filters the waveform signal acquired by the input interface unit 120. The feature extraction unit 122 extracts a feature value of the filtered waveform signal. The state prediction unit 123 executes a prediction operation to predict the degree of drowsiness of the driver based on the feature value extracted by the feature extraction unit 122. The state prediction unit 123 further executes a learning operation to optimize a coefficient parameter α (described in detail later) that determines the details of the prediction operation. The learning data generation unit 124 generates learning data DL based on the feature value extracted by the feature extraction unit 122. The learning data DL is data that the state prediction unit 123 uses when the state prediction unit 123 executes the learning operation. The learning data DL contains two types of data, that is, unlabeled data DLU and awake data DLP. The details of the unlabeled data DLU and awake data DLP will be described in detail later. The driving determination unit 125 determines whether the driver is driving a vehicle.

The storage device 13 is a hard disk drive or a storage medium, such as a flash memory. The storage device 13 stores any data related to the operation of the state prediction apparatus 1. Particularly, the storage device 13 stores the coefficient parameter α optimized through the learning operation and the learning data DL that is used in the learning operation. Other than that, the storage device 13 may store data indicating a degree of drowsiness predicted through the prediction operation, data indicating a waveform signal, data indicating extracted feature value, or other data. The state prediction apparatus 1 may include an external storage device that is able to transmit data to or receive data from the state prediction apparatus 1 via the communication device 5I, in addition to or instead of the storage device 13.

The display device 14 executes any display operation related to the operation of the state prediction apparatus 1. For example, the display device 14 displays the degree of drowsiness of the driver, predicted by the arithmetic unit 12.

The communication device 15 controls transmission and reception of data between the state prediction apparatus 1 and an external device. For example, the communication device 15 controls transmission and reception of data, stored in the storage device 13, between the state prediction apparatus 1 and an external device.

The operating device 16 receives an input operation of the driver (or any user who uses the state prediction apparatus 1) related to the operation of the state prediction apparatus 1. For example, the operating device 16 receives an input operation to make a request to start or stop the prediction operation.

The state prediction apparatus 1 is a mobile terminal (for example, a smartphone, or the like) including the arithmetic unit 12, the storage device 13, the display device 14, the communication device 1S, and the operating device 16. In this case, when the driver drives the vehicle with the mobile terminal, the degree of drowsiness of the driver driving the vehicle is predicted. The state prediction apparatus 1 may have a form different from that of such a mobile terminal as long as the state prediction apparatus 1 includes the arithmetic unit 12, the storage device 13, the display device 14, the communication device 15, and the operating device 16.

### (2) Operation of State Prediction Apparatus 1

Next, the operation of the state prediction apparatus 1 will be described. As described above, the state prediction apparatus 1 executes the prediction operation to predict the degree of drowsiness of the driver and the learning operation to optimize the coefficient parameter α (that is, to optimize the details of the prediction operation). Hereinafter, the prediction operation and the learning operation will be described sequentially.

### (2-1) Prediction Operation

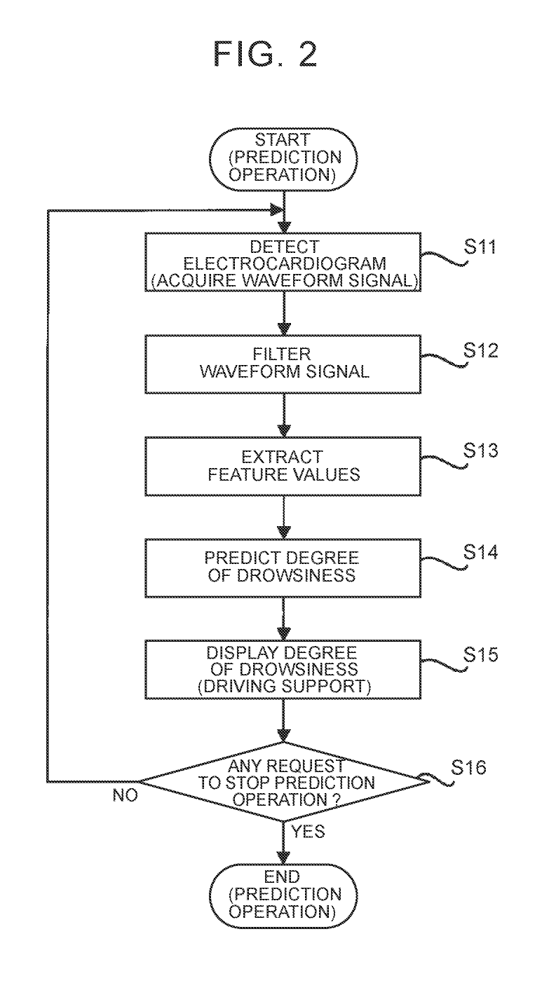

First, the prediction operation will be described with reference to FIG. 2. FIG. 2 is a flowchart showing the flow of the prediction operation.

As shown in FIG. 2, first, when the driver makes a request to start the prediction operation with the use of the operating device 16, an electrocardiogram is detected by the electrocardiogram sensor 11 (step S11). As a result, the input interface unit 120 acquires a waveform signal indicating the electrocardiogram (step S11).

After that, the filter unit 121 filters the waveform signal acquired in step S11 (step S12). The filtering may include a first process of removing noise from the waveform signal. The filtering may include a second process of removing deflections (that is, fluctuations) of the baseline of the waveform signal. In this case, the filter unit 121 may include, for example, a band pass filter.

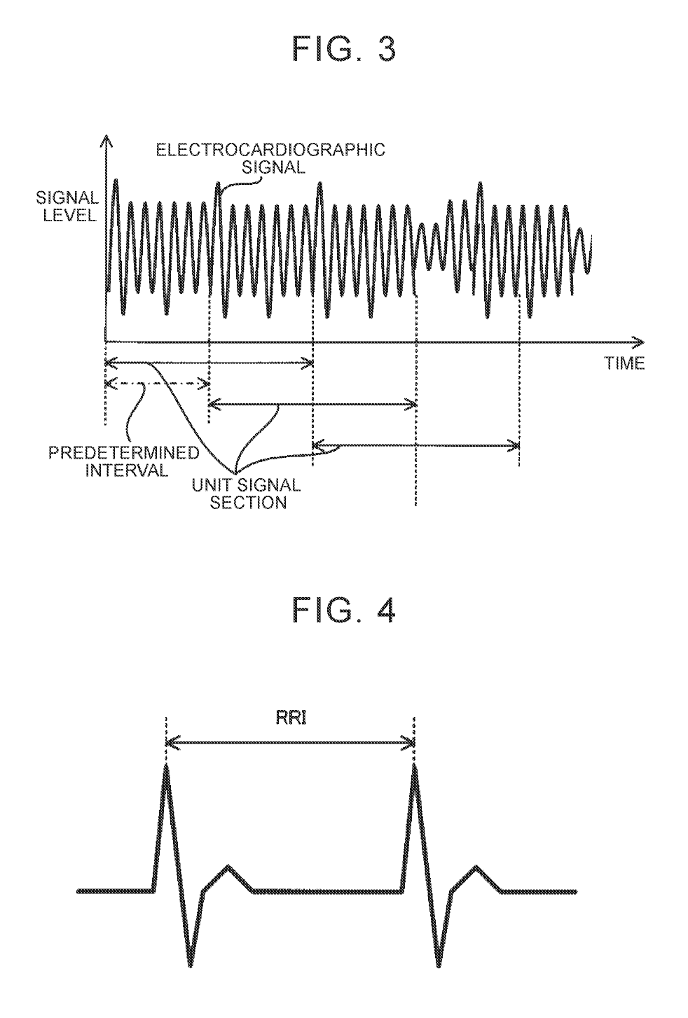

After that, the feature extraction unit 122 extracts a feature value of the filtered waveform signal (step S13). Specifically, the feature extraction unit 122 segments the waveform signal into unit signal sections each having a predetermined length of time (for example, from several tens of seconds to one hundred and several tens of seconds), as shown in FIG. 3. The feature extraction unit 122 extracts a feature value of each unit signal section. The feature extraction unit 122 repeats the process of extracting a feature value of each unit signal section at predetermined intervals (for example, from several tens of seconds to one hundred and several tends of seconds). FIG. 3 shows an example in which the predetermined interval is shorter than the length of time of each unit signal section. In this case, one of the unit signal sections partially overlaps another one of the unit signal sections.

A feature value is a parameter indicating the feature of a waveform signal. In the present embodiment, the feature extraction unit 122 extracts a feature value related to R-R-Interval (RRI: heart beat interval); however, the feature extraction unit 122 may extract any feature value. As shown in FIG. 4, RRI is an index corresponding to a time interval between peaks of R waves. A feature value related to RRI includes at least one of, for example, LF, HF, pNN50, RMSSD, SD/RMSSD, the variance of RRI, and the number of R waves (that is, the number of the peaks of the waveform). LF corresponds to the strength of a low-frequency component (for example, a signal component corresponding to a frequency of 0.04 Hz to 0.15 Hz) that is detected when RRI is subjected to fast Fourier transform (FFT). HF corresponds to the strength of a high-frequency component (for example, a signal component corresponding to a frequency of 0.15 Hz to 0.40 Hz) that is detected when RRI is subjected to FFT. pNN50 corresponds to the proportion of heart beats (or the number of heart beats) of which the difference between any adjacent two RRIs along the temporal axis exceeds 50 milliseconds. RMSSD corresponds to the square root of the average value of the squares of the difference between any adjacent two RRI along the temporal axis. SD/RMSSD corresponds to a value obtained by dividing the standard deviation of RRI by RMSSD.

However, depending on the condition of the waveform signal, the feature extraction unit 122 may be not able to appropriately extract a feature value. In this case, the feature extraction unit 122 may output an error flag indicating that it is not possible to appropriately extract a feature value. For example, a feature value that is extracted from a waveform signal of which the signal level (that is, amplitude) is too low (for example, the signal level is lower than a predetermined level) can be relatively low in reliability. Therefore, when the signal level of the waveform signal is too low, the feature extraction unit 122 may output an error flag. When an error flag is output, the state prediction unit 123 does not need to predict the degree of drowsiness of the driver.

The feature value (in addition, the error flag) extracted by the feature extraction unit 122 is output from the feature extraction unit 122 to the state prediction unit 123. Furthermore, the feature value (in addition, the error flag) extracted by the feature extraction unit 122 is stored in the storage device 13. At this time, as will be described in detail later, the storage device 13 may store the feature value extracted by the feature extraction unit 122 as at least part of the learning data DL. The feature value extracted by the feature extraction unit 122 in step S13 is one specific example of first input data in the supplemental notes described later.

Referring back to FIG. 2, after that, the state prediction unit 123 predicts the degree of drowsiness of the driver based on the feature value extracted in step S13 (step S14). Specifically, first, the state prediction unit 123 calculates a basis vector (x) expressed by the mathematical expression (1) based on the learning data DL stored in the storage device 13. In the mathematical expression (1), the variable x denotes the feature value (particularly, the feature value of a certain unit signal section) extracted in step S13, and, when the number of types of the extracted feature value is d, the variable x is a d-dimensional vector as expressed by the mathematical expression (2). A basis function is the mathematical expression (3). In the mathematical expression (1), the variable b denotes the number of dimensions of the basis vector ϕ(x). After that, the state prediction unit 123 reads out the coefficient parameter α stored in the storage device 13. The coefficient parameter α is a b-dimensional vector, and is expressed by the mathematical expression (4). After that, the state prediction unit 123 predicts the degree of drowsiness based on a linear-in-parameter model g(x) defined by the basis vector ϕ(x) and the coefficient parameter α. The linear-in-parameter model g(x) is expressed by the mathematical expression (5). Specifically, the state prediction unit 123 inputs the feature value x extracted in step S13 to the linear-in-parameter model g(x), and acquires the output value. The linear-in-parameter model g(x) outputs the output value appropriate for the degree of drowsiness of the driver. The degree of drowsiness is predicted from the feature value x. In the following description, the linear-in-parameter model g(x) outputs a smaller value as the degree of drowsiness of the driver increases (that is, as the likelihood that the driver is drowsy increases). However, as a result of optimization of the coefficient parameter α through the learning operation (described later), the linear-in-parameter model g(x) is optimized so as to output a negative value when the degree of drowsiness of the driver is relatively high (that is, the likelihood that the driver is drowsy is relatively high) or output a positive value when the degree of drowsiness of the driver is relatively low (that is, the likelihood that the driver is drowsy is relatively low). After that, when the output value of the linear-in-parameter model g(x) is greater than a predetermined threshold (for example, zero), the state prediction unit 123 predicts that the driver is not drowsy. On the other hand, when the output value of the linear-in-parameter model g(x) is less than the predetermined threshold (for example, zero), the state prediction unit 123 predicts that the driver is drowsy. Therefore, the state prediction unit 123 is substantially equivalent to a two-class classifier.

$$\begin{matrix}ϕ ( x ) = {( {ϕ}_{1} ( x ) , {ϕ}_{2} ( x ) , … , {ϕ}_{b} ( x ) )}^{T} & ( 1 ) \\ x = ( x 1 , x 2 , … , xd ) ∈ {R}^{d} & ( 2 ) \\ exp ( - \frac{{‖ x - {x}^{′} ‖}^{2}}{2 {h}^{2}} ) & ( 3 ) \\ α = {( {α}_{1} , {α}_{2} , … , {α}_{b} )}^{T} & ( 4 ) \\ g ( x ) = {α}^{T} ϕ ( x ) & ( 5 )\end{matrix}$$

After that, the display device 14 displays the degree of drowsiness of the driver, predicted in step S14 (step S15). Furthermore, when the state prediction unit 123 predicts that the driver is drowsy, the arithmetic unit 12 may issue an alarm to the driver where necessary. For example, the arithmetic unit 12 may display an alarm image raising an alarm to the driver by controlling the display device 14. For example, the arithmetic unit 12 may output an alarm sound raising an alarm to the driver by controlling a speaker (not shown). For example, the arithmetic unit 12 may generate vibrations raising an alarm to the driver by controlling a vibrator (not shown) built in a seat or steering wheel of the vehicle.

The processes of step S11 to step S15 described above are repeated until the driver makes a request to stop the prediction operation with the use of the operating device 16 (step S16).

### (2-2) Learning Operation

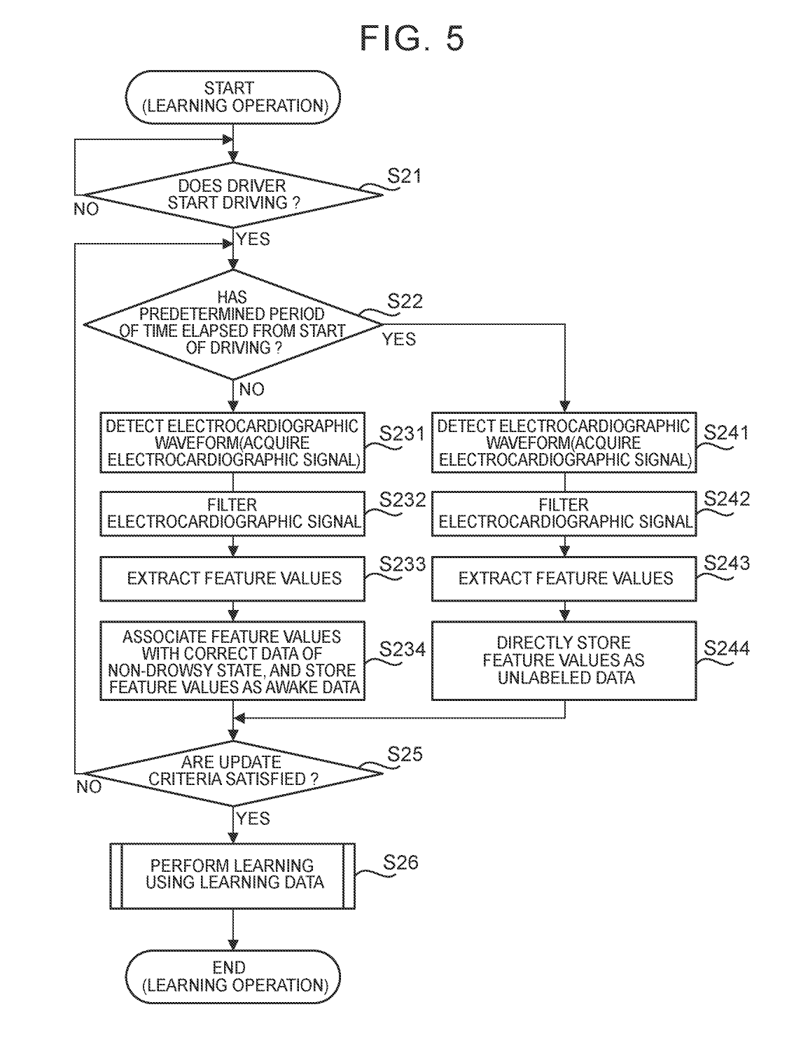

Next, the learning operation will be described. In the present embodiment, the state prediction apparatus 1 executes the learning operation after the state prediction apparatus 1 is taken possession of by the driver (in other words, after the state prediction apparatus 1 is put on the market). In other words, the state prediction apparatus 1 executes the learning operation after the state prediction apparatus 1 starts estimating the degree of drowsiness of the driver. At this stage, the driver drives the vehicle, so the state prediction apparatus 1 is able to execute the learning operation by using the detected electrocardiogram of the driver to be subjected to prediction of the degree of drowsiness by the state prediction apparatus 1. Hereinafter, the learning operation will be described with reference to FIG. 5. FIG. 5 is a flowchart showing the flow of the learning operation. The learning operation is typically executed in parallel with the above-described prediction operation; however, the learning operation may be executed during times when the prediction operation is not being executed.

As shown in FIG. 5, first, the learning data DL based on the detected electrocardiogram of the driver is acquired. Specifically, first, the arithmetic unit 12 determines whether the driver is driving a vehicle (step S21). For example, when the driver carries a mobile terminal including the arithmetic unit 12 as described above, the arithmetic unit 12 may predict the action of the driver based on a detected result of an acceleration sensor (not shown) or another sensor included in the mobile terminal and, when the arithmetic unit 12 predicts that the driver is in a vehicle, may determine that the driver is driving a vehicle. Alternatively, the arithmetic unit 12 may predict the proximity between the communication device 15 included in the mobile terminal and a communication device included in the vehicle based on a receiving signal received by the communication device 15, and, when the arithmetic unit 12 predicts that the communication device 15 and the communication device included in the vehicle are proximity to each other to such an extent that the driver is in the vehicle, may determine that the driver is driving a vehicle. Alternatively, when the state prediction apparatus 1 is installed in a vehicle, the arithmetic unit 12 may determine whether the driver is driving the vehicle based on the status of the vehicle (for example, the status of an ignition switch) or other statuses.

When the arithmetic unit 12 determines in step S21 that the driver is not driving a vehicle (No in step S21), the arithmetic unit 12 continues to determine whether the driver is driving a vehicle.

On the other hand, when the arithmetic unit 12 determines in step S21 that the driver is driving a vehicle (Yes in step S21), the driving determination unit 125 determines whether a predetermined period of time (for example, several minutes) has elapsed from when the driver starts driving the vehicle (step S22).

When the driving determination unit 125 determines in step S22 that the predetermined period of time has not elapsed yet from when the driver starts driving the vehicle (No in step S22), the arithmetic unit 12 predicts that the driver has just started driving the vehicle. In this case, the driver is relatively likely to be not drowsy. This is because a driver tends to get drowsy when the driver loosely continues driving a vehicle and, at this stage, the driver has not driven the vehicle over a long period of time yet. For this reason, a feature value x of the electrocardiogram, which is detected in this case, is likely to match the feature value x of the electrocardiogram of the driver in a non-drowsy state. That is, when the electrocardiogram of the driver is detected at this timing, the feature value x of the electrocardiogram of the driver in a non-drowsy state is likely to be extracted. Therefore, in the present embodiment, the electrocardiogram of the driver is detected by the electrocardiogram sensor 11 (step S231), the waveform signal is subjected to filtering by the filter unit 121 (step S232), and the feature value x of the waveform signal is extracted by the feature extraction unit 122 (step S233). The processes of step S231 to step S233 may be respectively the same as the processes of step S11 to step S13. The extracted feature value x is output from the feature extraction unit 122 to the learning data generation unit 124. After that, the learning data generation unit 124 generates data associating the extracted feature value x with correct data, as awake data DLP (step S234). The correct data indicates a correct answer that the driver is not drowsy. That is, the learning data generation unit 124 generates data containing correct data indicating that the driver is positive (so-called positive data) as part of the learning data DL (more specifically, the awake data DLP). The generated awake data DLP is stored in the storage device 13 (step S234).

On the other hand, when the driving determination unit 125 determines in step S22 that the predetermined period of time has already elapsed from when the driver starts driving the vehicle (Yes in step S22), the driver may be not drowsy or may be drowsy. That is, the degree of drowsiness of the driver is likely to fluctuate under the influence of various factors. In other words, the degree of drowsiness of the driver may be regarded as being inconstant. In this case as well, in the present embodiment, the electrocardiogram of the driver is detected by the electrocardiogram sensor 11 (step S241), the waveform signal is subjected to filtering by the filter unit 121 (step S242), and the feature value x of the waveform signal is extracted by the feature extraction unit 122 (step S243). The processes of step S241 to step S243 may be respectively the same as the processes of step S11 to step S13. The extracted feature value x is output from the feature extraction unit 122 to the learning data generation unit 124. The feature value x extracted in this case may match the feature value x of the electrocardiogram of the driver in a non-drowsy state or may match the feature value x of the electrocardiogram of the driver in a drowsy state. Therefore, the learning data generation unit 124 directly sets the extracted feature value x as unlabeled data DLU without associating the extracted feature value x with correct data indicating the actual degree of drowsiness of the driver (that is, without labeling correct data to the extracted feature value x) (step S244). That is, the learning data generation unit 124 generates data having no information about the degree of drowsiness of the driver (so-called unlabeled data) as part of the learning data DL (more specifically, unlabeled data DLU). The generated unlabeled data DLU is stored in the storage device 13 (step S244). The unlabeled data DLU created in step S244 is one specific example of second input data in the supplemental notes (described later).

After that, the state prediction unit 123 determines whether update criteria are satisfied (step S25). The update criteria represent conditions to be satisfied to start optimization of the coefficient parameter α using the learning data DL. The update criteria are, for example, conditions that the data amount of newly stored learning data DL (particularly, the data amount of the unlabeled data DLU) after the last optimization of the coefficient parameter α is greater than or equal to a predetermined amount. As the predetermined amount increases, the frequency the coefficient parameter α is optimized decreases. Therefore, the predetermined amount is set to an appropriate value such that the coefficient parameter α is optimized at an appropriate frequency.

When the state prediction unit 123 determines in step S25 that the update criteria are not satisfied yet (No in step S25), the operation from step S22 is repeated. That is, the learning data DI, is successively generated.

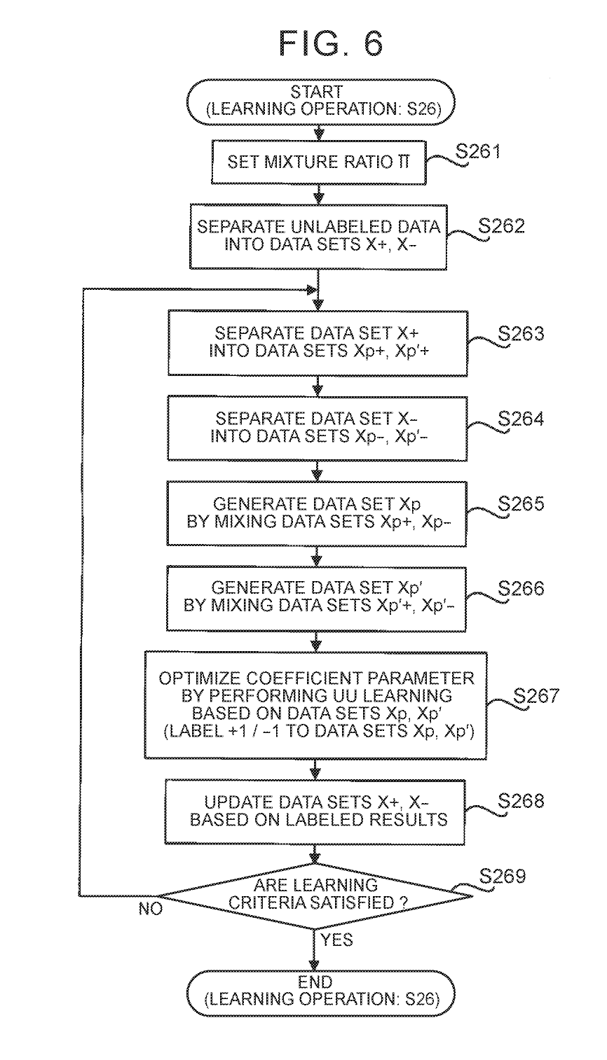

On the other hand, when the state prediction unit 123 determines in step S25 that the update criteria are satisfied (Yes in step S25), the state prediction unit 123 executes the learning process to optimize the coefficient parameter α using the learning data DL stored in the storage device 13 (step S26). Hereinafter, the flow of the learning process to optimize the coefficient parameter α in step S26 of FIG. 5 will be described with reference to FIG. 6. FIG. 6 is a flowchart showing the flow of the learning process for optimizing the coefficient parameter α in step S26 of FIG. 5.

As shown in FIG. 6, the state prediction unit 123 sets a mixture ratio Π (step S261). In the present embodiment, the state prediction unit 123 sets the mixture ratio Π to a desired value greater than zero and less than 0.5.

After that, the state prediction unit 123 separates the unlabeled data DLU stored in the storage device 13 into two data sets X (step S262).

For example, the state prediction unit 123 may separate the unlabeled data DLU into two data sets X with the use of an existing clustering/classification method. The existing clustering/classification method may be at least one of direct sign density difference (DSDD), kernel density estimation (KDE), and k-means clustering.

Alternatively, for example, the state prediction unit 123 may separate the unlabeled data DLU into two data sets X in accordance with predetermined separation criteria. One example of the predetermined separation criteria is date and time criteria on dates and times at which feature values x corresponding to unit data components that compose the unlabeled data DLU are extracted. In this case, for example, the state prediction unit 123 may separate the unlabeled data DLU into a data set X composed of feature values x extracted at dates and times that satisfy (or do not satisfy) date and time criteria and a data set X composed of feature values x extracted at dates and times that do not satisfy (or satisfy) the date and time criteria. For example, when unlabeled data DLU composed of four-day feature values x is stored in the storage device 13 as a result of driver's driving of a vehicle for four consecutive days, the state prediction unit 123 may separate the unlabeled data DLU into a data set X composed of the first-half two-day feature values x and a data set X composed of the second-half two-day feature values x. Of course, criteria other than date and time criteria may be used as the separation criteria.

The state prediction unit 123 further assigns any one of “+1 (that is, positive (P) label)” and “−1 (that is, negative (N) label)” as a temporary (in other words, apparent) label to each of the feature values x that compose one of the two data sets X generated by separating the unlabeled data DLU. The positive (P) label and the negative (N) label are output values of the state prediction unit 123. On the other hand, the state prediction unit 123 assigns the other one of “+1” and “−1” as a temporary label to each of the feature values x that compose the other one of the two data sets X generated by separating the unlabeled data DLU. That is, the state prediction unit 123 apparently separates the unlabeled data DLU into a data set X+ composed of feature values x assigned with the positive label (that is, feature values x assumed to be acquired from the driver in a non-drowsy state) and a data set X− composed of feature values x assigned with the negative label (that is, feature values x assumed to be acquired from the driver in a drowsy state). Of course, at this stage, the feature values x contained in the data set X+ do not need to be feature values x actually acquired from the driver in a non-drowsy state. Similarly, the feature values x contained in the data set X− do not need to be feature values x actually acquired from the driver in a drowsy state. In short, the state prediction unit 123 just needs to separate the unlabeled data DLU into a data set X+ apparently composed of feature values x assigned with the positive label and a data set X− apparently composed of feature values x assigned with the negative label. Since the positive label assigned to the data set X+ is only an apparent label (that is, a temporary or imaginary label), the data set X+ substantially corresponds to unlabeled data. For a similar reason, the data set X− also substantially corresponds to unlabeled data. The data set X+ and the data set X− are respectively one specific example of a first data portion and one specific example of a second data portion in the supplemental notes (described later).

At the timing at which the state prediction unit 123 executes the learning operation for the first time, the state prediction unit 123 has not possibly determined which one of the output value “+1” (or positive value) and the output value “−1” (or negative value) the state prediction unit 123 outputs for a feature value x acquired from the driver in a non-drowsy state. Similarly, the state prediction unit 123 has not possibly determined which one of the output value “+1” (or positive value) and the output value “−1” (or negative value) the state prediction unit 123 outputs for a feature value x acquired from the driver in a drowsy state. That is, it is possibly not determined which one of the positive label “+1” and the negative label “−1 I” corresponds to which one of a non-drowsy state and a drowsy state. For this reason, at the timing at which the state prediction unit 123 executes the learning operation for the first time, the state prediction unit 123 may determine by using the awake data DLP which one of the positive label “+1” and the negative label “−1” corresponds to which one of a non-drowsy state and a drowsy state. Specifically, as described above, the feature values x that compose the awake data DLP are feature values x acquired from the driver in a non-drowsy state. Therefore, the state prediction unit 123 associates output values, obtained by inputting the feature values x composing the awake data DLP into the linear-in-parameter model g(x), with a non-drowsy state. For example, when the output values obtained by inputting the feature values x composing the awake data DLP into the linear-in-parameter model g(x) are “+1 (or positive values)”, the state prediction unit 123 associates the positive label “+1” and the negative label “−1” with a non-drowsy state and a drowsy state, respectively. The following description will be made by way of an example in which the positive label “+1” and the negative label “−1” respectively correspond to a non-drowsy state and a drowsy state, as described above.

After that, the state prediction unit 123 separates the data set X+ into two data sets Xp+, Xp′+ based on the mixture ratio Π set in step S261 (step S263). Specifically, the state prediction unit 123 separates the data set X+ into two data sets Xp+, Xp′+ at the ratio of Π to (1−Π). That is, the state prediction unit 123 separates the data set X+ into two data sets Xp+, Xp′+ such that the ratio of the number of feature values x that compose the data set Xp+ to the number of feature values x that compose the data set Xp′+ is II to (1−Π). Alternatively, the state prediction unit 123 may separate the data set X+ into two data sets Xp+, Xp′+ with any separation method.

Similarly, the state prediction unit 123 separates the data set X− into two data sets Xp−, Xp′− based on the mixture ratio IT set in step S261 (step S264). Specifically, the state prediction unit 123 separates the data set X− into two data sets Xp−, Xp′− at the ratio of (1−Π) to Π. That is, the state prediction unit 123 separates the data set X− into two data sets Xp−, Xp′− such that the ratio of the number of feature values x that compose the data set Xp− to the number of feature values x that compose the data set Xp′− is (1−Π) to Π. Alternatively, the state prediction unit 123 may separate the data set X− into two data sets Xp−, Xp′− with any separation method.

After that, the state prediction unit 123 generates a data set Xp by mixing the data set Xp+ with the data set Xp−(step S265). In addition, the state prediction unit 123 generates a data set Xp′ by mixing the data set Xp′+ with the data set Xp′−(step S266). The data sets Xp, Xp′ are respectively one specific example of first mixed data and one specific example of second mixed data in the supplemental notes (described later).

After that, the state prediction unit 123 optimizes the coefficient parameter α by performing learning based on the data sets Xp, Xp′ corresponding to two groups of unlabeled data (hereinafter, referred to as unlabeled-unlabeled (UU) learning) (step S267). The UU learning of the present embodiment corresponds to an operation to cause the state prediction unit 123 to perform learning such that the coefficient parameter α is optimized by using two groups of unlabeled data having mutually different ratios of the number of feature values x assigned with a temporary positive label to the number of feature values x assigned with a temporary negative label. In the UU learning, the coefficient parameter α is optimized by using the difference in probability density between the two groups of unlabeled data. Specifically, when the difference in probability density on one class (for example, a class corresponding to a non-drowsy state) is positive, the difference in probability density on the other class (for example, a class corresponding to a drowsy state) is negative. The UU learning corresponds to a learning process of searching for a boundary at which the signs of the differences in probability density of two classes change by shifting a boundary (so-called hyperplane) for classifying feature values x that compose the two groups of unlabeled data (that is, searching for the coefficient parameter α by which the feature values x that compose the two groups of unlabeled data can be classified at the boundary at which the signs of the differences in probability density of the two classes change). Therefore, in some embodiments, the state prediction unit 123 uses a learning algorithm using a difference in probability density as a specific learning algorithm for executing the UU learning. One example of the learning algorithm using a difference in probability density may be at least one of the above-described DSDD and KDE.

The UU learning itself is described in Marthinus Christoffel du Plessis, Gang Niu, Masashi Sugiyama, “Clustering Unclustered Data: Unsupervised Binary Labeling of Two Datasets Having Different Class Balance”, Proc. TAAI2013, so the detailed description is omitted.

As a result of optimization of the coefficient parameter α through the UU learning, each of the feature values x that belong to the data set Xp and the feature values x that belong to the data set Xp′ can be classified into any one of the two classes by the boundary found through the UU learning. That is, the state prediction unit 123 is able to update the labels (here, temporary labels) assigned to the feature values x that compose the unlabeled data DLU based on the output values of the linear-in-parameter model g(x) defined by the optimized coefficient parameter α (step S267). Specifically, when the output value of the linear-in-parameter model g(x) to which a certain one of the feature values x is input is +1 (or positive value), the state prediction unit 123 is able to update the temporary label assigned to the certain one of the feature values x with the positive label. Similarly, when the output value of the linear-in-parameter model g(x) to which a certain one of the feature values x is input is −1 (or negative value), the state prediction unit 123 is able to update the temporary label assigned to the certain one of the feature values x with the negative label.

After that, the state prediction unit 123 updates the data set X+ and the data set X− based on the updated labels (step S268). Specifically, the state prediction unit 123 updates the data set X+ and the data set X− such that the data set composed of the feature values x assigned with the positive label in step S267 among the unlabeled data DLU is a new data set X+ and the data set composed of the feature values x assigned with the negative label in step S267 among the unlabeled data DLU is a new data set X−. The new data sets X+, X− substantially correspond to two new groups of unlabeled data that are classified by the boundary found through the UU learning.

After that, the state prediction unit 123 determines whether learning criteria for determining whether the coefficient parameter α has been appropriately optimized are satisfied (step S269). Any criteria may be used as the learning criteria. One example of the learning criteria may be, for example, learning criteria expressed by the mathematical expression (6). In the mathematical expression (6), the variable xᵢ denotes each of feature values x (that is, a d-dimensional vectors) that compose the data set Xp, and is expressed by the mathematical expression (7). The variable n denotes the number of the feature values x (that is, the number of the d-dimensional vectors) that compose the data set Xp. p(x) denotes the probability density of the feature values x that compose the data set Xp. In the mathematical expression (6), the variable x′ⱼ denotes a d-dimensional vector representing feature values x that compose the data set Xp′, and is expressed by the mathematical expression (8). The variable n′ denotes the number of the feature values x (that is, the number of the d-dimensional vectors) that compose the data set Xp′. p′(x) denotes the probability density of the feature values x that compose the data set Xp′. An example of the function R(z) in the mathematical expression (6) is expressed by the mathematical expression (9) and the mathematical expression (10). The variable X in the mathematical expression (6) denotes a hyper parameter.

$$\begin{matrix}J ( α ) = \frac{1}{n} {\sum }_{i = 1}^{n} R ( {α}^{T} ϕ ( {x}_{i} ) ) - \frac{1}{{n}^{′}} {\sum }_{j = 1}^{{n}^{′}} R ( {α}^{T} ϕ ( {x}_{j}^{′} ) ) + \frac{λ}{2} {α}^{T} α & ( 6 ) \\ {X}_{p} = {\{ {x}_{i} \}}_{i = 1}^{n} \begin{matrix}i . i . d . \\ ∼\end{matrix} p ( x ) & ( 7 ) \\ {X}_{p}^{′} = {\{ {x}_{j}^{′} \}}_{j = 1}^{{n}^{′}} \begin{matrix}i . i . d . \\ ∼\end{matrix} {p}^{′} ( x ) & ( 8 ) \\ R ( z ) = tanh ( z ) = \frac{exp ( z ) - exp ( - z )}{exp ( z ) + exp ( - z )} & ( 9 ) \\ R ( z ) = min ( 1 , max ( - 1 , z ) ) & ( 10 )\end{matrix}$$

When the state prediction unit 123 determines in step S269 that the learning criteria are satisfied (for example, the learning criteria have been minimized) (Yes in step S269), the arithmetic unit 12 ends the learning operation shown in FIG. 6. On the other hand, when the state prediction unit 123 determines in step S269 that the learning criteria are not satisfied (for example, there is still room for reducing the learning criteria) (No in step S269), the arithmetic unit 12 repeats the processes from step S263 again by using the data sets X+, X− updated in step S268. That is, in the present embodiment, the UU learning is repeated until the learning criteria are satisfied while the two data sets X+, X− that are used in the UU learning are updated.

The above-described learning criteria contain the hyper parameter X that should be set manually. The basis vector ϕ(x) can also contain a hyper parameter in some cases. For example, the variable h that denotes a base band width in the mathematical 26 expression (3) is an example of the hyper parameter. Therefore, to optimize the coefficient parameter α while setting the hyper parameter, the state prediction unit 123 optimizes the coefficient parameter at by performing the following procedure in some embodiments. Specifically, first, the state prediction unit 123 separates the unlabeled data DLU into first data and second data. The first data is used to optimize the coefficient parameter α after a candidate for the hyper parameter is set. The second data is used to examine (evaluate) the coefficient parameter α optimized by using the first data. For example, the state prediction unit 123 may use a data portion of a predetermined percentage (for example, 80%) of the unlabeled data DLU as first data and may use a data portion of the remainder (for example, 20%) of the unlabeled data DLU as second data. After that, the state prediction unit 123 generates the data sets Xp, Xp′ by executing the above-described processes of step S262 to step S266 of FIG. 6 over the first data. After that, the state prediction unit 123 sets a predetermined candidate value to the hyper parameter and then optimizes the coefficient parameter α by performing the UU learning using the data sets Xp, Xp′ generated from the first data. After that, the state prediction unit 123 examines the optimized coefficient parameter α by using the second data. Specifically, the state prediction unit 123 evaluates an evaluation formula obtained by removing the third regularization term from the above-described learning criteria by inputting the feature values x contained in the second data into the linear-in-parameter model g(x) that is determined by the coefficient parameter α optimized by using the first data. The state prediction unit 123 repeats such an operation until an optimum hyper parameter that minimizes the evaluation formula obtained by removing the third regularization term from the learning criteria is found. After that, the coefficient parameter α is optimized by using the optimum hyper parameter and the unlabeled data DLU (that is, both the first data and the second data). As a result, the coefficient parameter α is optimized. The optimized coefficient parameter α is stored in the storage device 13.

The above-described processes of step S21 to step S26 are repeated. That is, as long as the driver is driving the vehicle, collection of new unlabeled data DLU continues, and optimization of the coefficient parameter α continues by using newly collected unlabeled data DLU in addition to the already collected unlabeled data DLU.

### (3) Technical Advantageous Effects

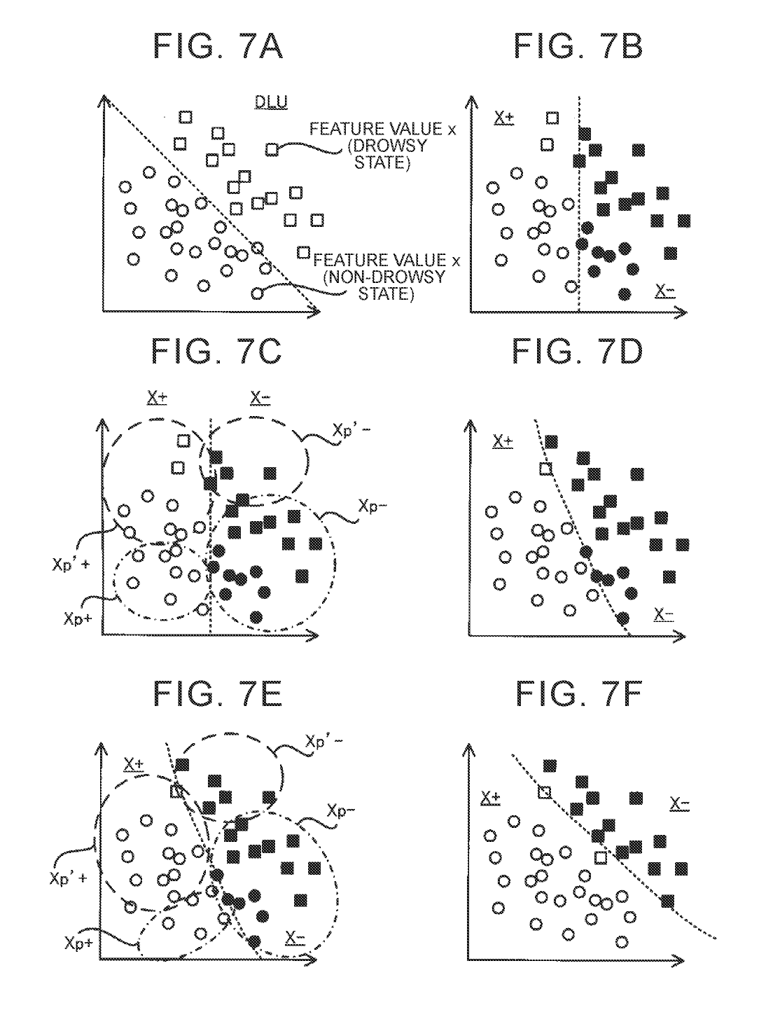

Next, technical advantageous effects that are obtained from the state prediction apparatus 1 of the present embodiment will be described. First, as a precondition to describe the technical advantageous effects, the above-described learning operation will be schematically described together with a state of feature values x in a feature value vector space with reference to FIG. 7A to FIG. 7F

FIG. 7A is a graph showing a state of distribution of the feature values x that compose the unlabeled data DLU in the feature value vector space. In FIG. 7A, the feature values x represented by the circle marks correspond to feature values x acquired from the driver in a non-drowsy state, and the feature values x represented by the square marks correspond to feature values x acquired from the driver in a drowsy state. Therefore, the dotted line in FIG. 7A corresponds to an ideal boundary with which the feature values x composing the unlabeled data DLU are classified into two classes. However, since correct data is not associated with the feature values x in the unlabeled data DLU, the state prediction apparatus 1 is not able to recognize that the feature values x represented by the circle marks correspond to the feature values x acquired from the driver in a non-drowsy state and the feature values x represented by the square marks correspond to the feature values x acquired from the driver in a drowsy state.

As shown in FIG. 7B, the state prediction unit 123 separates the unlabeled data DLU into data sets X+, X− (step S262 of FIG. 6). In FIG. 7B, the feature values x represented by the outline marks correspond to feature values x classified into the data set X+(that is, feature values x assigned with the temporary positive label), and the feature values x represented by the solid marks correspond to feature values x classified into the data set X− (that is, feature values x assigned with the temporary negative label). As shown in FIG. 73, each of the data sets X+, X− is relatively likely to contain both the feature values x acquired from the driver in a non-drowsy state and the feature values x acquired from the driver in a drowsy state.

After that, as shown in FIG. 7C, the state prediction unit 123 separates the data set X+ into data sets Xp+, Xp′+ and separates the data set X− into data sets Xp−, Xp′− (from step S263 to step S264 in FIG. 6). After that, the state prediction unit 123 generates a data set Xp by mixing the data sets Xp+, Xp- and generates a data set Xp′ by mixing the data sets Xp′+, Xp′− (from step S265 to step S266 in FIG. 6). In this case, a data portion of less than 50% of the data set X+ assigned with the temporary positive label becomes the data set Xp+, a remaining data portion greater than 50% of the data set X+ assigned with the temporary positive label becomes the data set Xp′+, a data portion greater than 50% of the data set X− assigned with the temporary negative label becomes the data set Xp−, and a remaining data portion of less than 50% of the data set X− assigned with the temporary negative label becomes the data set Xp′−. Therefore, the ratio of the number of the feature values x assigned with the temporary positive label to the number of the feature values x assigned with the temporary negative label in the data set Xp is relatively likely to be different from the ratio of the number of the feature values x assigned with the temporary positive label to the number of feature values x assigned with the temporary negative label in the data set Xp′.

After that, the state prediction unit 123 performs UU learning based on the data sets Xp+, Xp− (step S267 of FIG. 6). As a result, as shown in FIG. 7D, a search for a new boundary to classify the feature values x that compose the unlabeled data DLU into two classes is made, and the data sets X+, X− are updated based on the new boundary. As is apparent from a comparison between FIG. 7B and FIG. 7D, the boundary between the data sets X+, X− approaches the ideal boundary shown in FIG. 7A through UU learning.

After that, to perform UU learning again, the state prediction unit 123 generates data sets Xp, Xp′ from the new data sets X+, X− as shown in FIG. 7E. At this time, when the UU learning has been already performed once or more, the data set X+ is likely to contain the feature values x of the driver in a non-drowsy state more than the feature values x of the driver in a drowsy state and the data set X− is likely to contain the feature values x of the driver in a drowsy state more than the feature values x of the driver in a non-drowsy state. That is, when the UU learning has been already performed once or more, the feature values x of the driver in a non-drowsy state are likely to be unevenly distributed to the data set X+ and the feature values x of the driver in a drowsy state are likely to be unevenly distributed to the data set X−. As a result, the ratio of the number of feature values x of the driver in a non-drowsy state to the number of feature values x of the driver in a drowsy state in the data set Xp is further likely to be different from the ratio of the number of feature values x of the driver in a non-drowsy state to the number of feature values x of the driver in a drowsy state in the data set Xp′.

After that, the state prediction unit 123 performs UU learning again based on the data sets Xp+, Xp− (step S267 of FIG. 6). As a result, as shown in FIG. 7F, a search for a new boundary to classify the feature values x composing the unlabeled data DLU into two classes is made, and the data sets X+, X− are updated based on the new boundary. As is apparent from a comparison among FIG. 7B, FIG. 7D, and FIG. 7F, by repeating the UU learning, the boundary between the data sets X+, X− is likely to approach the ideal boundary shown in FIG. 7A.

As described above, with the state prediction apparatus 1, by using two groups of unlabeled data (that is, the data sets X+, X−), each of which is not associated with correct data, the UU learning for optimizing the coefficient parameter α is repeated while the two groups of unlabeled data are updated as needed. Therefore, in comparison with a state prediction apparatus of a comparative embodiment, in which UU learning is not repeated, the coefficient parameter α is likely to be optimized (that is, the prediction accuracy of the degree of drowsiness of the driver based on the electrocardiogram of the driver is likely to improve). Therefore, even when the degree of drowsiness of the driver is predicted based on the electrocardiogram (that is, human biological information) having the characteristics that the electrocardiogram contains a relatively large amount of noise information that has relatively little correlation with the status of the driver and a plurality of classes that are obtained through clustering tends to have overlaps, the coefficient parameter α is likely to be optimized. As a result, the state prediction apparatus 1 is able to relatively highly accurately predict the degree of drowsiness of the driver based on the electrocardiogram of the driver.

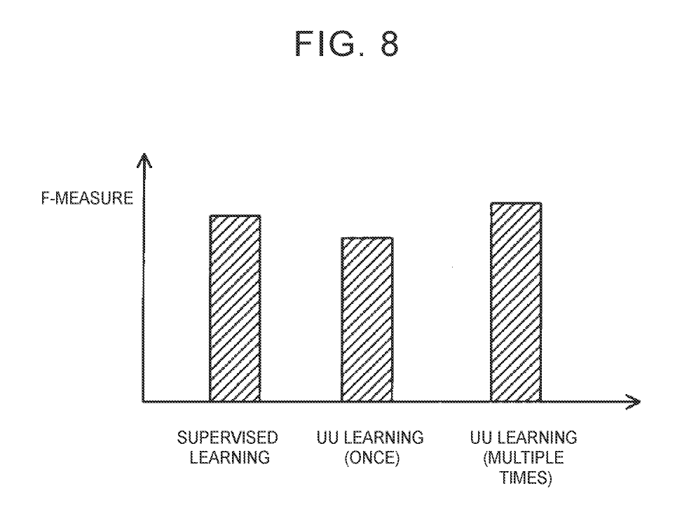

For example, FIG. 8 is a graph showing an F-measure on prediction of a degree of drowsiness in the case where the coefficient parameter α is optimized through supervised learning by using learning data containing feature values associated with correct data, an F-measure on prediction of a degree of drowsiness in the case where the coefficient parameter α is optimized through only once UU learning (that is, the routine from step S263 to step S268 in FIG. 6 is executed only once) by using unlabeled data DLU, and an F-measure on prediction of a degree of drowsiness in the case where the coefficient parameter α is optimized through repeated multiple-time UU learning (the routine from step S263 to step S268 in FIG. 6 is executed multiple times) by using unlabeled data DLU. An F-measure is an evaluation index corresponding to a harmonic mean between an prediction accuracy of a degree of drowsiness and a recall factor on prediction of a degree of drowsiness. An P-measure indicates more excellent performance to predict a degree of drowsiness as the F-measure increases. As shown in FIG. 8, the method of optimizing the coefficient parameter α through only once UU learning is poorer than the method of optimizing the coefficient parameter α through supervised learning; however, the method of optimizing the coefficient parameter α through repeated multiple-time UU learning is superior in performance to the method of optimizing the coefficient parameter α through supervised learning. Therefore, the experiments conducted by the inventors of the subject application also demonstrated that the coefficient parameter α was likely to be optimized through repeated multiple-time UU learning.

In addition, according to the research and survey of the inventors of the subject application, it turned out that, when UU learning was repeatedly performed by using two groups of unlabeled data, appropriate UU learning was performed when there was a difference in the ratio of the number of feature values x to be classified into one of classes (for example, feature values x of the driver in a non-drowsy state) to the number of feature values x to be classified into the other one of the classes (for example, feature values x of the driver in a drowsy state) between the two groups of unlabeled data. In keeping with this fact, in the present embodiment, UU learning is performed by using the data sets Xp, Xp′ that are obtained by partially mixing the data sets X+, X−. As described above, there is a relatively likely difference in the ratio of the number of feature values x to be classified into one of classes to the number of feature values x to be classified into the other one of the classes between the data sets Xp, Xp′. That is, the data sets Xp, Xp′ are likely to be two groups of unlabeled data between which there is a difference in the ratio of the number of feature values x to be classified into one of classes to the number of feature values x to be classified into the other one of the classes. As a result, the state prediction unit 123 is able to optimize the coefficient parameter ax by appropriately performing UU learning. For example, the state prediction unit 123 is able to efficiently optimize the coefficient parameter α and/or is able to optimize the coefficient parameter α such that the prediction accuracy improves.

### (4) Alternative Embodiments

In the above description, from feature values extracted until the predetermined period of time (for example, several minutes) elapses from when the driver starts driving the vehicle, awake data DLP of which the feature values are associated with correct data is generated. Instead, feature values extracted until the predetermined period of time elapses from when the driver starts driving the vehicle may be set as unlabeled data DLU of which the feature values are not associated with correct data.

In the above description, the state prediction unit 123 separates the data set X+ into data sets Xp+, Xp′+ and separates the data set X− into data sets Xp−, Xp′− and then generates a data set Xp by mixing the data sets Xp+, Xp− and generates a data set Xp′ by mixing the data sets Xp′+, Xp′−, Instead, the state prediction unit 123 does not need to separate the data set X+ into data sets Xp+, Xp′+ or does not need to separate the data set X− into data sets Xp−, Xp′−. In this case, the state prediction unit 123 may perform UU learning by using the data sets X+, X− as two groups of unlabeled data.

In the above description, the update criteria to be satisfied to start optimization of the coefficient parameter α using the learning data DL contain a condition related to the data amount of learning data DL (particularly, unlabeled data DLU) newly generated after the last optimization of the coefficient parameter α. Instead, the update criteria may contain other conditions in addition to or instead of the condition related to the data amount of learning data DL. For example, the update criteria may contain a condition related to the number of times the driver has driven the vehicle (for example, a condition that the number of times the driver has driven the vehicle after the last optimization of the coefficient parameter ca is greater than or equal to a predetermined number of times). For example, the update criteria may contain a condition related to a period of time during which the driver has been driving the vehicle (for example, a condition that a period of time during which the driver has been driving the vehicle after the last optimization of the coefficient parameter α is longer than or equal to a predetermined period of time). For example, the update criteria may contain a condition related to a request from the driver (for example, a condition that the driver is making a request to optimize the coefficient parameter α). Alternatively, the state prediction unit 123 may optimize the coefficient parameter α each time the state prediction unit 123 acquires new unlabeled data DLU without using the update criteria. That is, the state prediction unit 123 may perform online learning by using learning data DL.

In the above description, the state prediction apparatus 1 predicts the degree of drowsiness of the driver based on the electrocardiogram of the driver. Instead, the state prediction apparatus 1 may predict the degree of drowsiness of the driver based on other biological information of the driver in addition to or instead of the electrocardiogram of the driver. For example, the state prediction apparatus 1 may capture an image of the driver with a camera, may extract a feature value (for example, a feature value related to at least one of facial expression, behavior, and the like, of the driver) of the image obtained 20 through capturing by subjecting the image to image processing, and may predict the degree of drowsiness of the driver based on the extracted feature value.

In the above description, the state prediction apparatus 1 predicts the degree of drowsiness of the driver based on the biological information of the driver. Instead, the state prediction apparatus 1 may predict any status of the driver based on the biological information of the driver. For example, the state prediction apparatus 1 may extract a feature value related to the brain waves of the prefrontal area of the driver (for example, a feature value related to the content of theta waves) from the biological information of the driver and may predict the degree of concentration (in other words, the degree of relaxation) of the driver on driving based on the extracted feature value. In this case, the state prediction apparatus 1 may acquire biological information after the driver has been relaxed for a certain period of time or longer, and may generate data of which a feature value of the acquired biological information is associated with correct data indicating a correct answer that the driver is relaxed as data corresponding to the awake data DLP. The state prediction apparatus 1 may acquire the biological information of the driver after the driver has done a specified job (at least one of, for example, document preparation, reading, video watching, and the like), and may generate a feature value of the acquired biological information as data corresponding to the unlabeled data DLU.

In the above description, the state prediction apparatus 1 predicts the status of the driver based on the biological information of the driver. Instead, the state prediction apparatus 1 may predict the status of any user other than the driver based on the biological information of the any user. Alternatively, the state prediction apparatus 1 may predict the status of any user based on any action information (that is, information related to the action of the user) of the any user in addition to or instead of biological information. For example, the state prediction apparatus 1 may predict the status of any user by using the action information of the user, which is obtained from an acceleration sensor, an angular velocity sensor, or another sensor, attached to the arm or trunk of the user. Alternatively, the state prediction apparatus 1 may predict the status of any user based on any information of the any user in addition to or instead of biological information. Alternatively, considering that biological information corresponds to input information and the predicted status of a user corresponds to output information, the state prediction apparatus 1 may output any output information based on any input information in addition to or instead of estimating the status of the user based on biological information. In this case as well, when the above-described learning operation is performed, the above-described advantageous effects are obtained.

### (5) Supplemental Notes

With regard to the above-described embodiment, the following supplemental notes will be further described.

### (5-1) Supplemental Note 1

A state prediction apparatus includes an information processing device. The information processing device is configured to acquire first input data related to at least one of biological information and action information of a user. The information processing device is configured to execute a prediction operation to predict a status of the user based on the first input data. The information processing device is configured to repeat a learning process for optimizing details of the prediction operation by using a first data portion and second data portion of second input data. The second input data is related to at least one of the biological information and action information of the user. The second input data is not associated with correct data indicating the status of the user. The second data portion is different from the first data portion.

With this state prediction apparatus, the learning process for optimizing the details of the prediction operation is repeated by using two data portions (that is, the first and second data portions), each of which is not associated with the correct data. Therefore, even when at least one of the biological information and the action information having the characteristics that the at least one of the biological information and the action information contains a relatively large amount of noise information that has relatively little correlation with the status of the user and a plurality of classes that are obtained through clustering tends to have overlaps is used, the details of the prediction operation are likely to be optimized. Therefore, the state prediction apparatus is able to appropriately predict the status of the user based on at least one of the biological information and action information of the user.

### (5-2) Supplemental Note 2

In the state prediction apparatus, the information processing device may be configured to perform the learning process again. The teaming process may include an operation to, each time the learning process is performed, newly set the first and second data portions from the second input data based on a result of the performed learning process and, after that, optimize the details of the prediction operation by using the newly set first and second data portions.

With this state prediction apparatus, the learning process for optimizing the details of the prediction operation is repeated while the first and second data portions are appropriately updated based on the result of the learning process. Therefore, in comparison with a state prediction apparatus of a comparative embodiment, in which first and second data portions are not updated and a learning process is not repeated, the details of the prediction operation are likely to be optimized.

### (5-3) Supplemental Note 3

In the state prediction apparatus, the information processing device may be configured to predict which one of two classes the status of the user belongs to based on the first input data. The learning process may include an operation to optimize the details of the prediction operation such that each of data components that compose the second input data is classified into any one of the two classes by using the first and second data portions. The information processing device may be configured to perform the learning process again. The learning process includes an operation to, each time the learning process is performed, set a data portion composed of data components of the second input data, classified into one of the two classes, as the new first data portion and set a data portion composed of data components of the second input data, classified into the other one of the two classes, as the new second data portion, and, after that, optimize the details of the prediction operation such that each of data components that compose the second input data is classified into any one of the two classes by using the newly set first and second data portions.

With this state prediction apparatus, the learning process for optimizing the details of the prediction operation is repeated while the first and second data portions are appropriately updated based on the result of the learning process. Therefore, in comparison with a state prediction apparatus of a comparative embodiment, in which the first and second data portions are not updated and the learning process is not repeated, the details of the prediction operation are likely to be optimized.

### (5-4) Supplemental Note 4

In the state prediction apparatus, the information processing device may be configured to predict which one of two classes the status of the user belongs to based on the first input data. The learning process may include an operation to (i) generate first mixed data and second mixed data from the first and second data portions, the first mixed data containing a first portion of the first data portion and a second portion of the second data portion, the second mixed data containing a third portion of the first data portion and a fourth portion of the second data portion, the third portion being different from the first portion, the fourth portion being different from the second portion, and (ii) optimize the details of the prediction operation such that each of data components that compose the second input data is classified into any one of the two classes by using the first and second mixed data.

With this state prediction apparatus, the first and second mixed data are likely to be two data portions that are not associated with correct data and between which there is a difference in the ratio of data components to be classified into one of the two classes to data components to be classified into the other one of the two classes. As a result, the information processing device is able to appropriately perform the learning process.

### (5-5) Supplemental Note 5

In the state prediction apparatus, the information processing device may be configured to perform the learning process again. The learning process may include an operation to, each time the learning process is performed, set a data portion composed of data components of the second input data, classified into one of the two classes, as the new first data portion and set a data portion composed of data components of the second input data, classified into the other one of the two classes, as the new second data portion, and, after that, optimize the details of the prediction operation such that each of data components that compose the second input data is classified into any one of the two classes by using the newly set first and second data portions.

With this state prediction apparatus, in comparison with a state prediction apparatus of a comparative embodiment, in which the first and second data portions are not updated and the learning process is not repeated, the details of the prediction operation are likely to be optimized.

Furthermore, as the learning process is performed more number of times, data components to be classified into one of two classes are likely to be unevenly distributed to the first data portion and data components to be classified into the other one of the two classes are likely to be unevenly distributed to the second data portion. In this case, since the first and second mixed data are generated by partially mixing the first and second data portions, as the learning process is performed more number of times, the ratio of data components of the first mixed data, classified into one of the two classes, to data components of the first mixed data, classified into the other one of the two classes, is likely to be different from the ratio of data components of the second mixed data, classified into one of the two classes, to data components of the second mixed data, classified into the other one of the two classes. Therefore, the information processing device is able to appropriately perform the learning process.

The disclosure is not limited to the above-described embodiment. The embodiment of the disclosure may be modified as needed without departing from the scope or idea of the disclosure that can be read from the appended claims and the full text of the specification. The technical scope of the disclosure also encompasses state prediction apparatuses with such modifications.

What is claimed is:

1. A state prediction apparatus comprising an information processing device configured to
acquire first input data related to at least one of biological information and action information of a user,
execute an prediction operation to predict a status of the user based on the first input data, and
repeat a learning process for optimizing details of the prediction operation by using a first data portion and second data portion of second input data, the second input data being related to at least one of the biological information and action information of the user, the second input data being not associated with correct data indicating the status of the user, the second data portion being different from the first data portion.

2. The state prediction apparatus according to claim 1, wherein:
the information processing device is configured to perform the learning process again; and
the learning process includes an operation to, each time the learning process is performed, newly set the first and second data portions from the second input data based on a result of the performed learning process and, after that, optimize the details of the prediction operation by using the newly set first and second data portions.

3. The state prediction apparatus according to claim 1, wherein:
the information processing device is configured to predict which one of two classes the status of the user belongs to based on the first input data;
the learning process includes an operation to optimize the details of the prediction operation such that each of data components that compose the second input data is classified into any one of the two classes by using the first and second data portions;
the information processing device is configured to perform the learning process again; and
the learning process includes an operation to, each time the learning process is performed, set a data portion composed of data components of the second input data, classified into one of the two classes, as the new first data portion and set a data portion composed of data components of the second input data, classified into the other one of the two classes, as the new second data portion, and, after that, optimize the details of the prediction operation such that each of data components that compose the second input data is classified into any one of the two classes by using the newly set first and second data portions.

4. The state prediction apparatus according to claim 1, wherein:
the information processing device is configured to predict which one of two classes the status of the user belongs to based on the first input data; and
the learning process includes an operation to
(i) generate first mixed data and second mixed data from the first and second data portions, the first mixed data containing a first portion of the first data portion and a second portion of the second data portion, the second mixed data containing a third portion of the first data portion and a fourth portion of the second data portion, the third portion being different from the first portion, the fourth portion being different from the second portion, and
(ii) optimize the details of the prediction operation such that each of data components that compose the second input data is classified into any one of the two classes by using the first and second mixed data.

5. The state prediction apparatus according to claim 4, wherein:
the information processing device is configured to perform the learning process again; and
the learning process includes an operation to, each time the learning process is performed, set a data portion composed of data components of the second input data, classified into one of the two classes, as the new first data portion and set a data portion composed of data components of the second input data, classified into the other one of the two classes, as the new second data portion, and, after that, optimize the details of the prediction operation such that each of data components that compose the second input data is classified into any one of the two classes by using the newly set first and second data portions.

6. The state prediction apparatus according to claim 1, wherein the user is a driver of a vehicle.

7. The state prediction apparatus according to claim 1, wherein the biological information is one of an electrocardiogram of the user, a facial expression of the user, a behavior of the user, and brain waves of a prefrontal area of the user.

8. A state prediction method comprising:
acquiring first input data related to at least one of biological information and action information of a user,
executing an prediction operation to predict a status of the user based on the first input data; and
repeating a learning process for optimizing details of the prediction operation by using a first data portion and second data portion of second input data, the second input data being related to at least one of the biological information and action information of the user, the second input data being not associated with correct data indicating the status of the user, the second data portion being different from the first data portion.
